(19) United States
(12) Patent Application Publication
(10) Pub. No.: US 2003/0194162 A1
(43) Pub. Date: Oct. 16, 2003

(54) Fluorinated and halogenated phosphinic acids and their active metal derivatives

(76) Inventors: Robert M. Mininni, New Hope, PA (US); Yousef Mohajer, Richmond, VA (US); Anthony Garito, Radnor, PA (US); Anna A. Panackal, Philadelphia, PA (US); Joseph Virgilo, Wayne, NJ (US)

Correspondence Address: Finnegan, Henderson, Farabow,, Garrett & Dunner, L.L.P., 1300 I Street, N.W., Washington, DC, 20005-3315, US

(21) Appl. No.: 10/227,290

(22) Filed: Aug. 26, 2002

Related U.S. Application Data
(60) Provisional application No. 60/367,648, filed on Mar. 26, 2002.

(51) Int. Cl. G02F 1/01; C07F 9/22; C07F 9/28; C07F 9/02

(52) U.S. Cl. 385/1; 558/203; 562/9; 562/25

(57) ABSTRACT

Compounds of formula (I), methods of making and method of using (including optical compositions and devices) are provided. The compounds are

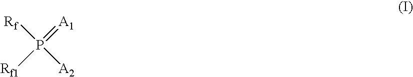

where

A₁ is selected from O and S; A₂ is selected from —OH, —SH, and —OR₃;

R_{f} and R_{f1} can be the same or different, can be branched or unbranched, can be linked to form cyclic or extended structures, and are selected from halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes, halogenated silazanes, halogenated olefins, perfluorinated C₁₋₂₀ alkyl, perfuorinated C₁₋₆ alkyl C₁₋₁₀ alkyl ethers, n-C₈F₁₇, n-C₆F₁₃, n-C₄F₉, n-C₂F₅, (CF₃)₂CF(CF₂)₄, n-C₁₀F₂₁, n-C₁₂F₂₅, (CF₃)₂CF(CF₂)₆, and (CF₃)₂CFO(CF₂)₂;

and R₃ can be branched or unbranched and is selected from C₁₋₁₅ alkyl, C₃₋₁₅ aryl, C₄₋₁₅ alkylaryl, and C₄₋₁₅ arylalkyl. Wherein, (i) if R_{f} and R_{f1} are the same and selected from n-C₂F₅, n-C₄F₉, n-C₆F₁₃, n-C₇F₁₅, and n-C₈F₁₇, then A₁ is not O; (ii) if R_{f} and R_{f1}, are the same and selected from n-C₂F₅, n-C₄F₉, n-C₆F₁₃, n-C₇F₁₅, and n-C₈F₁₇, then A₂ is not —OH; and (iii) if A₁ is O, and if R_{f} and R_{f1} are the same and selected from n-C₆F₁₃, n-C₇F₁₅ and n-C₈F₁₇, then A₂ is not —OCH₃.

### DESCRIPTION OF THE INVENTION

This claims priority to U.S. Provisional Application No. 60/367,648, filed Mar. 26, 2002, which is hereby incorporated herein by reference in its entirety.

### FIELD OF THE INVENTION

The present invention relates generally to optical materials. In particular, this invention relates to ligand compositions for use in optical materials, especially for use in optical gain media.

### BACKGROUND OF THE INVENTION

As fiber optics are increasingly employed in long distance communications metropolitan network and local access communications, there is an increasing need for efficient, compact optical amplification.

Optical communication systems based on glass optical fibers (GOFs) allow communication signals to be transmitted not only over long distances with low attenuation but also at extremely high data rates, or bandwidth capacity. This capability arises from the propagation of a single optical signal mode in the low-loss windows of glass located at the near-infrared wavelengths of 0.85 μm, 1.3 μm, and 1.55 μm. Present technology has moved to erbium doped fused silica fiber for optical amplification. Since the introduction of erbium-doped fiber amplifier (EDFA), the last decade has witnessed the emergence of single-mode GOF as the standard data transmission medium for wide area networks (WANs), especially in terrestrial and transoceanic communication backbones. In addition, the bandwidth performance of single-mode GOF has been vastly enhanced by the development of dense wavelength division multiplexing (DWDM), which can couple up to 160 channels of different wavelengths of light into a single fiber, with each channel carrying, gigabits of data per second. Moreover, a signal transmission of 1 terabit (10¹² bits) per second was achieved over a single fiber on a 100-channel DWDM system. In these and other technologies, the bandwidth capacities of the communication networks are increasing at rates of as much as an order of magnitude per year.

The success of single-mode GOF in long-haul communication backbones has given rise to the new technology of optical networking. The universal objective is to integrate voice, video, and data streams over all-optical systems as communication signals make their way from WANs down to smaller local area networks (LANs), fiber to the curb (FTTC), fiber to the home (FTTH), and finally to the end user by fiber to the desktop (FFTD). Examples, such as the recent explosion of the Internet and use of the World Wide Web, demand higher bandwidth performance in short- and medium-distance applications. Yet, as the optical network nears the end user, starting at the LAN stage, the system is characterized by numerous fiber connections, splices, and couplings, especially those associated with splitting of the input signal into numerous channels. All of these introduce optical loss. To compensate for the loss penalty, current solutions rely on expensive EDFAs that are bulky at fiber lengths of about 40 m. The cost of a typical commercial EDFA can reach many tens of thousands of dollars. Thus, to complete the planned build-out for FTTC, and FFTD in the U.S. would require millions of amplifiers and hundreds of billions of dollars.

An EDFA module is made up of a number of components. One of the most critical components in the module is the erbium doped silica fiber (EDF). Present EDF is limited by low concentrations of erbium atoms (maximum is about 0.1%), clustering that leads to quenching of photoluminescence, a relatively narrow emission band, a highly wavelength dependent gain spectrum, and an inability to be fabricated in a compact, planar geometry. Efforts have been directed toward the use of other rare earth ions in both fused silica glass hosts and other glasses including fluoride, tellurite, and phosphate glasses. To this point, those efforts have been limited by the fundamental materials properties of the glass media with regard to their ability to dissolve rare earth atoms, mechanical properties, thermal stability, and other key properties. The compositions described herein can be used to make optical materials (including optical fibers) that avoid these and other problems.

Recently, considerable level of interest has been directed to halogenated phosphinic acids and their derivatives and their use in optical fibers. Many other potential applications have been identified including use in optical devices (e.g., amplifiers, waveguides, or other alcohols), electrolytes in fuel cells, surface active agents, surface modifiers, and inorganic removal compositions. A major obstacle to application of these compounds is the lack of a commercially viable method of synthesis. Shreeve et al. (Inorg. Chem., 2000, vol. 39, pages 1787-1789) report synthesis of various fluorophosphinic acids via oxidation of corresponding iodobis (perfluoro alkyl) phosphines. However, there are several problems with their method including the use of white and red phosphorus, which are dangerous and have extremely toxic side products. Also, reactions with the phosphorus are difficult to scale to commercial levels. Further, intermediates are produced from their reaction of perfluoro alkyl iodides with white or red phosphorous. These unwanted reaction by-products (e.g., (R_{f})₃P, (R_{f})₂Pl, and (R_{f})₁Pl₂) must be separated before the desired material, (R_{f})₂Pl, is converted to its chloride derivatives and finally oxidized with NO₂ to yield the desired product, (R_{f})₂P(O)OH. This additional purification procedure is cumbersome and further hinders commercialization.

Here, we resolve at least one of these and other problems by teaching novel and facile routes for manufacture of this class of chemicals. Many of the exemplary embodiments include “single pot” syntheses, thereby foregoing purification of intermediates. Additionally, metal complexes made from these compounds posses exceptional properties useful for optical materials (e.g., long fluorescent lifetimes).

### SUMMARY OF THE INVENTION

Halogenated phosphinic acids, halogenated phosphinic acid-like compounds, derivatives therefrom, and methods for synthesizing and using these compounds are provided. These compounds can be present in optical compositions for use in optical materials and devices.

One exemplary embodiment of the invention includes novel compounds of formula (I)

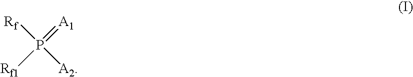

The symbols are defined below.

In another embodiment of this invention, a method of making (R_{f})₂PA₁A₂ is provided. This method includes:

(a) admixing R_{f}I with RMgBr or RLi at a temperature below about −40° C. to produce a first mixture;

(b) stirring the first mixture for between about 2 to about 6 hours at temperature below about −40° C.;

(c) admixing POCl₃ or PSCl₃ to the first mixture at a temperature below about −40° C. to produce a second mixture;

(d) maintaining the second mixture for about 2 to about 4 hours at a temperature between about −40° C. and about −50° C.;

(e) warming the second mixture to between about 15° C. to about 30° C.;

(f) optionally, admixing NaSH to the second mixture and refluxing for about 2 hours to about 6 hours to produce a third mixture;

(g) admixing water or R₃OH to the second mixture or the third mixture; and

(h) recovering (R_{f})₂PA₁A₂.

In yet another embodiment of this invention, a method of making (R_{f})(R_{f1})PA₁A₂ is provided. The method includes:

(a) admixing R_{f}I with RMgBr or RLi at a temperature below about −40° C. to make a first mixture;

(b) stirring the first mixture for between about 2 to about 6 hours at temperature below about −40° C.;

(c) admixing POCl₃ or PSCl₃ to the first mixture at a temperature below about −40° C. to produce a second mixture;

(d) maintaining said second mixture for about 2 to about 4 hours at a temperature between about −40° C. and about −50° C.;

(e) admixing R_{f1}I with R₁MgBr or R₁Li in a second container at a temperature below about −40° C. to make a third mixture;

(f) stirring said third mixture for between about 2 hours and about 6 hours at temperature below about −40° C.;

(g) admixing the contents of said second container and said first container to make a fourth mixture;

(h) warming said fourth mixture to between about 15° C. to about 30° C.;

(i) optionally, admixing NaSH to said fourth mixture and refluxing for about 2 hours to about 6 hours to produce a fifth mixture;

(j) admixing water or R₃OH to said fourth mixture or said fifth mixture; and

(k) recovering (R_{f})(R_{f1})PA₁A₂.

The symbols used above are defined hereinbelow.

Objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate non-limiting embodiments of the invention and together with the description, serve to explain the principles of the invention.

### BRIEF DESCRIPTION OF THE DRAWING

FIG. 1 is an experimental setup used to measure the fluorescence lifetimes.

### DESCRIPTION OF THE EMBODIMENTS

The following definitions are used throughout the application:

A₁ and A₃ can be the same or different and are selected from O and S.

A₂ is selected from —OH, —SH, and —OR₃.

R_{f}, R_{f1}, and R_{f2} can be the same or different, can be branched or unbranched, can be linked to form cyclic or extended structures, and are selected from halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes, halogenated silazanes, halogenated olefins, fluorinated alkyl, fluorinated aryl, fluorinated cyclic alkyl, fluorinated arylalkyl, fluorinated alkylaryl, fluorinated polyether, fluorinated thioether, fluorinated ether thioether, fluorinated aklyl amino groups, fluorinated alkylene, fluorinated silylene, fluorinated siloxanes, fluorinated silazanes, fluorinated olefins, branched perfluorinated C₁₋₂₀ alkyl, unbranched perfluorinated C₁₋₂₀ alkyl, perfuorinated C₁₋₆ alkyl C₁₋₁₀ alkyl ethers, n-C₈F₁₇, n-C₆F₁₃, n-C₄F₉, n-C₂F₅, (CF₃)₂(CF₂)₄, n-C₁₀F₂₁, n-C₁₂F₂₅, (CF₃)₂CF(CF₂)₆, and (CF₃)₂CFO(CF₂)₂.

R and R₁ can be the same or different and are selected from an alkyl, aryl, alkylaryl, arylalkyl, methyl, ethyl, bezyl, and phenyl.

R₃ can be branched or unbranched and is selected from C₁₋₆ alkyl, C₁₋₁₅ alkyl, C₃₋₁₅aryl, C₄₋₁₅ alkylaryl, and C₄₋₁₅ arylalkyl.

X is selected from Cl, Br, and I.

m is an integer selected from one through ten.

n is an integer greater than or equal to two.

p is an integer selected from zero through three.

In one embodiment of the invention, some compounds are represented by formula (I) as follows:

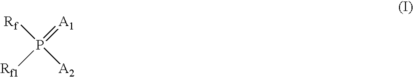

In another embodiment of this invention, if R_{f} and R_{f1} are the same and selected from n-C₂F₅, n-C₄F₉, n-C₆F₁₃, n-C₇F₁₅, and n-C₈F₁₇, then A₁ is not O.

In another embodiment of the invention, if R_{f} and R_{f1} are the same and selected from n-C₂F₅, n-C₄F₉, n-C₆F₁₃, n-C₇F₁₅, and n-C₈F₁₇, then A₂ is not —OH.

In yet another embodiment, if A₁ is O, and if R_{f} and R_{f1} are the same and selected from n-C₆F₁₃, n-C₇F₁₅, and n-C₈F₁₇, then A₂ is not —OCH₃.

In still another embodiment of the invention,

(i) if R_{f} and R_{f1} are the same and selected from n-C₂F₅, n-C₄F₉, n-C₆F₁₃, n-C₇F₁₅, and n-C₈F₁₇, then A₁ is not O;

(ii) if R_{f} and R_{f1} are the same and selected from n-C₂F₅, n-C₄F₉, n-C₆F₁₃, n-C₇F₁₅ and n-C₈F₁₇, then A₂ is not —OH; and

(iii) if A₁ is O, and if R_{f} and R_{f1} are the same and selected from n-C₆F₁₃, n-C₇F₁₅, and n-C₈F₁₇, then A₂ is not —OCH₃.

In yet another embodiment, the R_{f} and R_{f1} can be the same or different, can be branched or unbranched, and are selected from perfluorinated C₁₋₂₀ alkyl, perfuorinated C₁₋₆ alkyl C₁₋₁₀ alkyl ethers, n-C₈F₁₇, n-C₆F₁₃, n-C₄F₉, n-C₂F₅, (CF₃)₂CF(CF₂)₄, n-C₁₀F₂₁, n-C₁₂F₂₅, (CF₃)₂CF(CF₂)₆, and (CF₃)₂CFO(CF₂)₂.

In still another embodiment, the compound is selected from (n-C₈F₁₇)₂POOH, (n-C₆F₁₃)₂POOH , (n-C₄F₉)₂POOH, (n-C₂F₅)₂POOH, ((CF₃)₂CF(CF₂)₄)₂POOH, (n-C₁₀F₂₁)₂POOH, (n-C₁₂F₂₅)₂POOH, ((CF₃)₂CF(CF₂)₆)₂POOH, ((CF₃)₂CFO(CF₂)₂)₂POOH, (n-C₈F₁₇)(n-C₆F₁₃)POOH, (n-C₈F₁₇)(n-C₄F₉)POOH, (n-C₈F₁₇)(n-C₁₀F₂₁)POOH, (n-C₈F₁₇)₂POSH, ((CF₃)₂CF(CF₂)₆)₂POSH, and (n-C₈F₁₇)₂POOCH₃.

In yet another embodiment, compositions can include any of the above-listed embodiments having formula (I). These compositions can be used in a variety of optical applications, including optical fiber, amplifiers, lasers, modulators, switches, etc.

The following synthetic reactions are also illustrative of this invention.

Synthesis of Grignard reagents:

R_{f}I+RMgX→R_{f}MgX

R_{f}I+RLi→R_{f}Li

Other similar reagents using Na, K, and Ca can be readily prepared using methods known to those of ordinary skill in the art. These exemplary Grignard and Grignard-like reagents (e.g., those similar reagents using Li, Na, K, and Ca) can be used with any of the processes shown below.

nR_{f}MgI+POCl₃→then 1.

+H₂O→(R_{f})₂P(O)OH

nR_{f}MgI+PCl₃→then 2.

+H₂O then

+H₂O₂→(R_{f})₂P(O)OH

In this 2^{nd} method, PCl₃ can be substituted for POCl₃ and similar conditions can be used with both compounds. Hydrogen peroxide can be used in this 2^{nd} method to oxidize the phosphorus to its pentavalent state.

nR_{f}MgI+(RO)ₚP(O)Cl₍₃₋ₚ₎→then 3.

+H₂O→(R_{f})₂P(O)OH

In this 3^{rd} method, (RO)ₚPOCl₍₃₋ₚ₎ can be substituted for POCl₃ and similar conditions can be used with both compounds.

nR_{f}MgI+(RO)ₚPCl₍₃₋ₚ₎→then 4.

+H₂O→then

+H₂O₂→(R_{f})₂P(O)OH

In this 4^{th} method, (RO)ₚPCl₍₃₋ₚ₎ can be substituted for POCl₃ and similar conditions can be used with both compounds. Hydrogen peroxide can be used in this 4^{th} method to oxidize the phosphorus to its pentavalent state.

R_{f}I+P(OR)₃→R_{f}P(O)(OR)₂ 5.

R_{f}P(O)(OR)₂+Cl₃SiH→R_{f}P(OR)₂

R_{f}P(OR)₂+R_{f1}I→R_{f}R_{f1}P(O)OR

R_{f}R_{f1}P(O)OR+H₂O→R_{f}R_{f1}P(O)OH

This 5^{th} method provides phosphinic acids with different R_{f} groups.

R_{f}MgI+(OR)₂P(O)H→(R_{f})₂P(O)H 6.

(R_{f})₂P(O)H+H₂O₂→(R_{f})₂P(O)OH

R_{f}MgI+PSCl₃→(R_{f})₂P—S—P(S)(R_{f})₂ 7.

(R_{f})₂P—S—P(S)(R_{f})₂+SOCl₂→(R_{f})₂P(O)Cl

(R_{f})₂P(O)Cl +H₂O→(R_{f})₂P(O)OH

R_{f}P(O)Cl₂+R_{f1}MgBr→R_{f}R_{f1}P(O)Cl 8.

R_{f}R_{f1}P(O)Cl+H₂O→R_{f}R_{f1}P(O)OH

This 8^{th} method provides phosphinic acids with different R_{f} groups.

R_{f}MgBr+CCl₃P(O)(OC₂H₅)₂→(CCl₃)(R_{f})P(O)OC₂H₅ 9.

(CCl₃)(R_{f})P(O)OC₂H₅+H₂O→(CCl₃)(R_{f})P(O)OH

This 9^{th} derivative contains chlorinated as well as fluorinated phosphinic acid.

(RO)₃P+CFR_{f}Br₂→(RO)₂P—O—CF(R_{f})P(O)(OR)₂ 10.

(RO)₂P—O—CF(R_{f})P(O)(RO)₂+R_{f1}MgBr→

then +H₂O→R_{f1}P(O)(OH)—CFR_{f}—P(O)(OH)R_{f1}

The compounds made in the 10^{th} method have two adjacent phosphinic acids plus two different R_{f} groups.

(RO)₃P+BrCFR_{f}R_{f1}→(RO)₂P—O—CFR_{f}R_{f1} 11.

(RO)₂P—O—CFR_{f}R_{f1}+R_{f2}MgBr

Then +H₂O →

R_{f2}P(O)(OH)CFR_{f}R_{f1}

With this 11^{th} method, one can obtain phosphinic acid derivatives with three distinct R_{f} groups on the same molecule.

CF₃—CFl—O—CF₃+LiAlH₄, NaBH₄ or others→CF₃—FC⁽⁻¹⁾—O—CF₃ 12.

then +POCl₃

then +H₂O→

(CF₃CF(OCF₃))₂P(O)(OH)

Compounds resulting from the 12^{th} method may be soluble in many perfluoro-oxy solvents.

CF₃—CFH—O—CF₃+LiAlH₄, NaBH₄ or others→CF₃—FC⁽⁻¹⁾—O—CF₃ 13.

then +POCl₃

then +H₂O→

(CF₃CF(OCF₃))₂P(O)(OH)

The compounds resulting from the 13^{th} method may be soluble in many perfluoro-oxy solvents.

Analogous compounds of the above reactions, where POCl₃ has been replaced with PSCl₃, have resulted in compounds with the functionality of P(S)SH, P(S)OH, P(S)OR₃, or P(O)SH.

Immediately below is an exemplary embodiment of a synthesis via a Grignard-like reaction using phorphorium oxychloride.

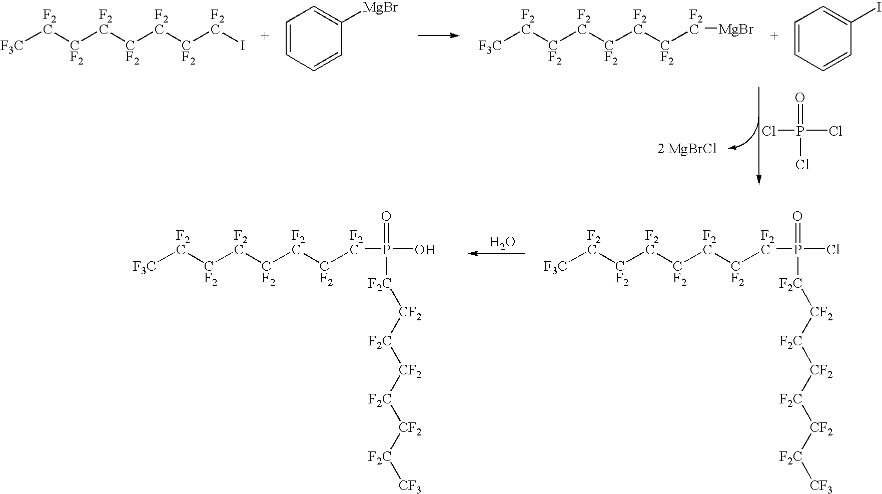

Immediately below is an exemplary embodiment of a synthesis via a Grignard-like reaction using a protective approach.

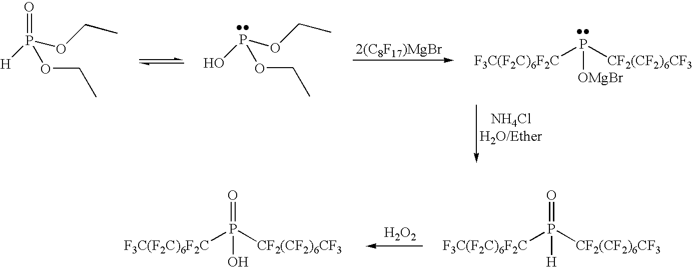

Immediately below is an exemplary embodiment of a synthesis via a Michaelis-Arbuzov step using trimethyl phosphite.

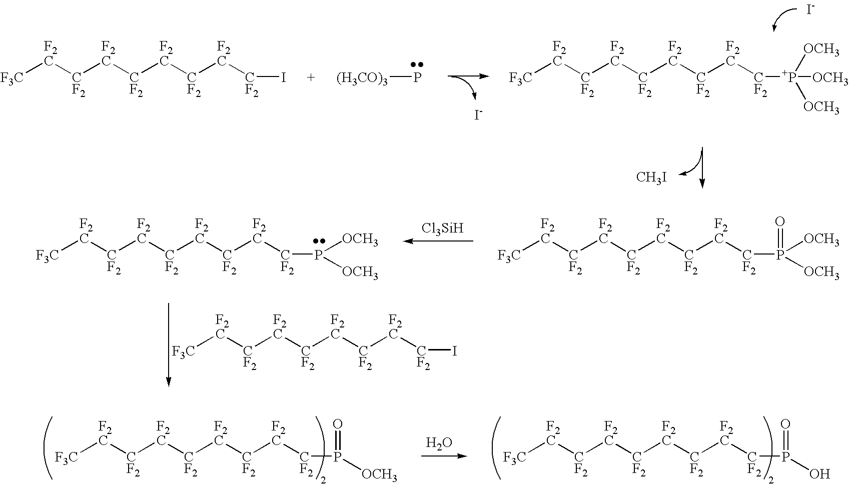

An Exemplary Method of Making (R_{f})₂PA₁A₂

An illustrative method of making (R_{f})₂PA₁A₂ consistent with this invention is provided. The method can include: (a) admixing R_{f}I with RMgBr at a temperature below about −40° C. to make a first mixture. Alternatively, step (a) can use another reagent instead of RMgBr, including RLi, or any other suitable Grignard-like reagent, or any suitable reagent useful for a similar purpose. Step (a) may also be performed at a temperature below about −45° C., or between about −40° C. and about −116° C., or between about −45° C. and about −116° C.

In step (b), stirring of the first mixture can occur for between about 2 hours to about 6 hours at temperature below about −40° C. In one particular embodiment, the temperature can be between about −40° C. and about −50° C. In other exemplary embodiments of this method, the stirring in step (b) can occur for about 4 hours. In other exemplary embodiments of this method, the stirring in step (b) can occur at about −45° C.

In step (c), POCl₃ or PSCl₃ can be admixed to the first mixture a temperature below about −40° C. to produce a second mixture. In other exemplary embodiments of this method, the temperature in step (c) can be below about −45° C., or below about −50° C., or between about −45° C. and about −116° C.

In step (d), the second mixture can be maintained for about 2 hours to about 4 hours at a temperature between about −40° C. and about −50° C. In one particular embodiment, step (d) can occur for about 3 hours. In other embodiments, step (d) can occur at a temperature at about −45° C.

In step (e), the second mixture can be warmed to about room temperature. In another embodiment, the mixture can be warmed to a temperature between about 15° C. to about 30° C., or to a temperature between about 20° C. to about 25° C., or to a temperature of about 22.5° C.

In optional step (f), NaSH can be added to the second mixture and refluxed for about 2 hours to about 6 hours to produce a third mixture. In one particular embodiment, refluxing can occur for about 4 hours.

In step (g), the second or third mixture can be admixed with a compound selected from water, methanol, ethanol, a branched C₃₋₆ alcohol, an unbranched C₃₋₆ alcohol, a C₃₋₆ aryl alcohol, a branched C₃₋₁₅ alcohol, an unbranched C₃₋₁₅ alcohol, a C₃₋₁₅ aryl alcohol, a C₄₋₁₅ alkylaryl alcohol, and a C₄₋₁₅ arylalkyl alcohol. In exemplary embodiments of this method, the admixing in step (g) can take place over a period of time between about 5 minutes and about 2 hours, or between about 5 minutes and about 30 minutes, or between about 5 minutes and about 10 minutes. The admixing can occur slowly enough to reduce heating sufficient to decrease solvent boil-off.

In step (h), (R_{f})₂PA₁A₂ is recovered and purified. In exemplary embodiments of this method, step (h) can be performed by extraction, distillation, boiling, washing, trituration (with hexane, methylene chloride, toluene or any other suitable solvent), filtration, column chromatography, or any other well know suitable methods for purification, isolation, or recovery. In other exemplary embodiments of this method, step (h) can be performed comprising (1) complexation with alcohols (e.g., methanol, ethanol, etc . . . ), (2) purification by solvent extraction, and (3) azeotropic distillation of the complexing alcohol.

It will be appreciated that steps (a)-(h) need not be performed in the order listed.

An Exemplary Method of Making (R_{f})(R_{f1})PA₁A₂

In another exemplary embodiment consistent with this invention, a method of making (R_{f})(R_{f1})PA₁A₂ is provided. The method can include step (a): admixing R_{f}I with RMgBr in a first container at a temperature below about −40° C. to make a first mixture. In another embodiment, step (a) can use another reagent instead of RMgBr, including RLi or any other suitable Grignard-like reagent, or any suitable reagent useful for a similar purpose. In other exemplary embodiments of this method, step (a) can be performed at a temperature below about −45° C., or between about −40° C. and about −116° C., or between about −45° C. and about −116° C.

In step (b), stirring of the first mixture occurs for between about 2 hours and about 6 hours at a temperature below about −40° C. In another embodiment, the temperature in step (b) can be between about −40° C. and about −50° C. In another embodiment of this method, the stirring in step (b) can be for about 4 hours. In another embodiment, step (b) can be performed at a temperature at about −45° C.

In step (c), POCl₃ or PSCl₃ can be admixed to the first mixture in the first container at a temperature below about −40° C. to produce a second mixture. In another embodiment, the stirring in step (c) can be performed at a temperature below about −45° C. or between about −45° C. and about −116° C., or between about −50° C. and about −116° C.

In step (d), the second mixture can be maintained for between about 2 hours and about 4 hours at a temperature between about −40° C. and about −50° C. In another embodiment, step (d) can be performed for about 3 hours. In another embodiment, step (d) can be performed at a temperature of about −45° C.

Step (e) occurs in a second container. In step (e), R_{f2}I with R₁MgBr can be admixed at a temperature below about −40° C. to make a third mixture. In another embodiment, step (e) can use another reagent instead of RMgBr, including RLi or any other suitable Grignard-like reagent, or any suitable reagent useful for a similar purpose. Step (e) can also be performed at a temperature below about −45° C., or between about −40° C. and about −116° C., or between about −45° C. and about −116° C.

In step (f), stirring of the third mixture can occur for between about 2 hours and about 6 hours at a temperature below about −40° C. Alternatively, the temperature in step (f) can be held between about −40° C. and about −50° C. In one other embodiment, the stirring in step (f) can occur for about 4 hours. The stirring in step (f) can be at about −45° C.

In step (g), the contents of the second container can be admixed with the contents of the first container to make a fourth mixture.

In step (h), the fourth mixture can be warmed to about room temperature. Alternatively, the warming in step (h) can be a temperature between about 15° C. and about 30° C., or between about 20° C. and about 25° C., or at about 22.5° C.

In step (i), NaSH can be added to the fourth mixture, if desired, and can be refluxed for about 2 hours to about 6 hours to make a fifth mixture. Refluxing in step (i) can occur for about 4 hours.

In step (j) there can be admixing to the fourth mixture or the fifth mixture of a compound selected from water, methanol, ethanol, a branched C₃₋₆ alcohol, an unbranched C₃₋₆ alcohol, a C₃₋₆ aryl alcohol, a branched C₃₋₁₅ alcohol, an unbranched C₃₋₁₅ alcohol, a C₃₋₁₅ aryl alcohol, a C₄₋₁₅ alkylaryl alcohol, and a C₄₋₁₅ arylalkyl alcohol. Admixing in step (j) can take place over about 5 minutes to about 2 hours, or about 5 minutes to about 30 minutes, or about 5 minutes to about 10 minutes. In one embodiment, the admixing in step (j) can occur slowly enough to reduce heating sufficient to decrease solvent boil-off.

In step (k), (R_{f})(R_{f1})PA₁A₂ can be recovered and purified. In another embodiment, step (k) can be performed by distillation, boiling, washing, trituration (with hexane, methylene chloride, toluene or any other suitable solvent), filtration, or any other well know suitable method for purification, isolation, or recovery.

It will be appreciated that steps (a)-(k) need not be performed in the order listed.

Optical materials and devices that use these materials can be made with these compounds. Examples of optical devices include optical films, optical fibers, and optical waveguides. These devices can be produced by methods found in copending Mohajer et al. U.S. application Ser. No. 10/______, “Optical Gain Media and Methods for Making and Using the Same”, filed Aug. 26, 2002, which is hereby incorporated by reference in its entirety.

### EXAMPLES

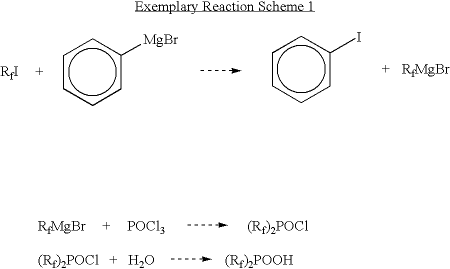

### Example 1

### Bis(n-perfluorooctyl)phosphinic acid; (n-C₈F₁₇)₂POOH

n-C₈F₁₇I (205.0 g, 0.375 mol) was dissolved in 1000 ml of dry ethyl ether to form a solution. The solution was cooled to −60 to −70° C. in a dry ice/acetone bath. PhMgBr (3M in diethyl ether, 125 ml, 0.375 mol) was added so that the temperature remained below −45° C. The mixture was stirred for four hours at −45° C. POCl₃ (12.6 ml, 0.136 mol) was added so that the temperature remained below −45° C. The mixture was maintained at −40 to −50° C. for 3 hours and then allowed to warm to room temperature overnight. Water (100 ml) was added over 5-10 minutes and the solution stirred for one hour. The ether layer was separated and dried with magnesium sulfate. The ether was filtered and concentrated on a rotary evaporator to yield a semi-solid product. The product was triturated three times with hexane, three times with methylene chloride, and dried on high vacuum to yield a solid product. The solid was suspended in a flask with 700 ml of toluene and the flask was fitted with a Dean-Stark trap. The toluene was refluxed and about 100 ml of toluene was removed via the Dean-Stark trap. The toluene in the Dean-Stark trap was clear when the water was essentially removed. The suspension was cooled and the product filtered and dried on high vacuum to yield 109.8 g (89.5%) of bis(n-perfluorooctyl)phosphinic acid, melting point (hereinafter, “mp”) 203-205° C.

### Example 2

### Bis(n-perfluorohexyl)phosphinic acid; (n-C₆F₁₃)₂POOH

n-C₆F₁₃I (111.5 g, 0.25 mol) was dissolved in 600 ml of dry ethyl ether to form a solution. The solution was cooled to −60 to −70° C. in a dry ice/acetone bath. PhMgBr (3M in diethyl ether, 82.5 ml, 0.25 mol) was added so that the temperature remained below −45° C. The mixture was stirred for four hours at −45° C. POCl₃ (7.7 ml, 0.083 mol) was added so that the temperature remained below −45° C. The mixture was maintained at −40 to −50° C. for 3 hours and then allowed to warm to room temperature overnight. Water (150 ml) was added over 5 to 10 minutes and the solution stirred for one hour. The ether layer was separated and dried with magnesium sulfate. The ether was filtered and concentrated on a rotary evaporator to yield a semi-solid product. The product was triturated three times with hexane, three times with methylene chloride, and dried on high vacuum to yield a solid product. The solid was suspended in a flask with 400 ml of toluene and the flask was fitted with a Dean-Stark trap. The toluene was refluxed and about 100 ml of toluene was removed via the Dean-Stark trap. The toluene in the Dean-Stark trap was clear when water was essentially removed. The suspension was cooled and the product filtered and dried on high vacuum to yield 44.5 g (76.3%) of bis(n-perfluorohexyl)phosphinic acid, mp 155-158° C.

### Example 3

### Bis(n-perfluorobutyl)phosphinic acid; (n-C₄F₉)₂POOH

n-C₄F₉I (173.0 g, 0.50 mol) was dissolved in 900 ml of dry ethyl ether to form a solution. The solution was cooled to −60 to −70° C. in a dry ice/acetone bath.

PhMgBr (3M in diethyl ether, 158 ml, 0.48 mol) was added so that the temperature remained below −45° C. The mixture was stirred for four hours at −45° C. POCl₃ (15.5 ml, 0.167 mol) was added so that the temperature remained below −45° C. The mixture was maintained at −40 to −50° C. for 3 hours and then allowed to warm to room temperature overnight. Water (250 ml) was added over 5 to 10 minutes and the solution stirred for one hour. The ether layer was separated and dried with magnesium sulfate. The ether was filtered and concentrated on a rotary evaporator to yield a oil. The product was triturated three times with hexane, three times with methylene chloride and dried on high vacuum to yield a oil. The oil was suspended in a flask with 400 ml of toluene and the flask was fitted with a Dean-Stark trap. The toluene was refluxed and about 100 ml of toluene was removed via the Dean-Stark trap. The toluene in the Dean-Stark trap was clear when water was essentially removed. The suspension was cooled and the toluene removed by decantation and the oil dried on high vacuum to yield 47.4 g (47%) of bis(n-perfluorobutyl)phosphinic acid.

### Example 4

### Bis(perfluoroethyl)phosphinic acid; (C₂F₅)₂POOH

C₂F₅I (24.6 g, 0.10 mol) was dissolved in 500 ml of dry ethyl ether to form a solution. The solution was cooled to −60 to −70° C. in a dry ice/acetone bath. PhMgBr (3M in diethyl ether, 32 ml, 0.11 mol) was added so that the temperature remained below −45° C. The mixture was stirred for four hours at −45° C. POCl₃ (3.7 ml, 0.04 mol) was added so that the temperature remained below −45° C. The mixture was maintained at −40 to −50° C. for 3 hours and then allowed to warm to room temperature overnight. Water (50 ml) was added over 5 to 10 minutes and the solution stirred for one hour. The ether layer was separated and dried with magnesium sulfate. The ether was filtered and concentrated on a rotary evaporator to yield a oil. The product was triturated three times with hexane, three times with methylene chloride and dried on high vacuum to yield a oil. The oil was suspended in a flask with 400 ml of toluene and the flask was fitted with a Dean-Stark trap. The toluene was refluxed and about 100 ml of toluene was removed via the Dean-Stark trap. The toluene in the Dean-Stark trap was clear when the water was essentially removed. The suspension was cooled and the toluene removed by decantation and the oil dried on high vacuum to yield 4.7 g (39%) of bis(perfluoroethyl)phosphinic acid.

### Example 5

### Bis(perfluoro-5-methylhexyl)phosphinic acid; ((CF₃)₂CF(CF₂)₄)₂POOH

(CF₃)₂CF(CF)₄I (148.8 g, 0.30 mol) was dissolved in 1100 ml of dry ethyl ether to form a solution. The solution was cooled to −60 to −70° C. in a dry ice/acetone bath. PhMgBr (3M in diethyl ether, 96 ml, 0.32 mol) was added so that the temperature remained below −45° C. The mixture was stirred for four hours at −45° C. POCl₃ (11.1 ml, 0.12 mol) was added so that the temperature remained below −45° C. The mixture was maintained at −40 to −50° C. for 3 hours and then allowed to warm to room temperature overnight. Water (100 ml) was added over 5 to 10 minutes and the solution stirred for one hour. The ether layer was separated and dried with magnesium sulfate. The ether was filtered and concentrated on a rotary evaporator to yield a oily product. The product was triturated three times with hexane, three times with methylene chloride and dried on high vacuum into yield a oily product. The oil was suspended in a flask with 400 ml of toluene and the flask was fitted with a Dean-Stark trap. The toluene was refluxed and about 100 ml of toluene was removed via the Dean-Stark trap. The toluene in the Dean-Stark trap was clear when the water was essentially removed. The suspension was cooled and the product filtered and dried on high vacuum to yield 76.8 g (79.8%) of bis(perfluoro-5-methylhexyl)phosphinic acid, mp 91-94° C.

### Example 6

### Bis(n-perfluorodecyl)phosphinic acid; (n-C₁₀F₂₁)₂POOH

n-C₁₀F₂₁I (25.0 g, 0.0387 mol) was dissolved in 350 ml of dry ethyl ether to form a solution. The solution was cooled to −60 to −70° C. in a dry ice/acetone bath. PhMgBr (3M in diethyl ether, 13 ml, 0.039 mol) was added so that the temperature remained below −45° C. The mixture was stirred for four hours at −45° C. POCl₃ (1.5 ml, 0.016 mol) was added so that the temperature remained below −45° C. The mixture was maintained at −40 to −50° C. for 3 hours and then allowed to warm to room temperature overnight. Water (50 ml) was added over 5 to 10 minutes and the solution stirred for one hour. The ether layer was separated and dried with magnesium sulfate. The ether was filtered and concentrated on a rotary evaporator to yield a semi solid product. The product was triturated three times with hexane, three times with methylene chloride and dried on high vacuum to yield a solid product. The solid was suspended in a flask with 250 ml of toluene and the flask was fitted with a Dean-Stark trap. The toluene was refluxed and about 100 ml of toluene was removed via the Dean-Stark trap. The toluene in the Dean-Stark trap was clear when the water was essentially removed. The suspension was cooled and the product filtered and dried on high vacuum to yield 3.9 g (23%) of bis(n-perfluorodecyl)phosphinic acid, mp 210-220° C.

### Example 7

### Bis(n-perfluorododecyl)phosphinic acid; (n-C₁₂F₂₅)₂POOH

n-C₁₂F₂₅I (13.0 g, 0.0174 mol) was dissolved in 300 ml of dry ethyl ether to form a solution. The solution was cooled to −60 to −70° C. in a dry ice/acetone bath. PhMgBr (3M in diethyl ether, 5.3 ml, 0.016 mol) was added so that the temperature remained below −45° C. The mixture was stirred for four hours at −45° C. POCl₃ (0.6 ml, 0.0064 mol) was added so that the temperature remained below −45° C. The mixture was maintained at −40 to −50° C. for 3 hours and then allowed to warm to room temperature overnight. Water (50 ml) was added over 5 to 10 minutes and the solution stirred for one hour. The ether layer was separated and dried with magnesium sulfate. The ether was filtered and concentrated on a rotary evaporator to yield a semi solid product. The product was triturated three times with hexane, three times with methylene chloride and dried on high vacuum to yield a solid product. The solid was suspended in a flask with 100 ml of toluene and the flask was fitted with a Dean-Stark trap. The toluene was refluxed and about 20 ml of toluene was removed via the Dean-Stark trap. The toluene in the Dean-Stark trap was clear when the water was essentially removed. The suspension was cooled and the product filtered and dried on high vacuum to yield 1.5 g of bis(n-perfluorododecyl)phosphinic acid, mp 165° C.

### Example 8

### Bis(perfluoro-7-methyloctyl)phosphinic acid; ((CF₃)₂CF(CF₂)₆)₂POOH

(CF₃)₂CF(CF)₆I (178.8 g, 0.30 mol) was dissolved in 1100 ml of dry ethyl ether to form a solution. The solution was to −60 to −70° C. in a dry ice/acetone bath. PhMgBr (3M in diethyl ether, 96 ml, 0.32 mol) was added so that the temperature remained below −45° C. The mixture was stirred for four hours at −45° C. POCl₃ (11.1 ml, 0.12 mol) was added so that the temperature remained below −45° C. The mixture was maintained at −40 to −50° C. for 3 hours and then allowed to warm to room temperature overnight. Water (100 ml) was added over 5 to 10 minutes and the solution stirred for one hour. The ether layer was separated and dried with magnesium sulfate. The ether was filtered and concentrated on a rotary evaporator to yield an oily product. The product was triturated three times with hexane, three times with methylene chloride and dried on high vacuum to yield a oily product. The oil was suspended in a flask with 500 ml of toluene and the flask was fitted with a Dean-Stark trap. The toluene was refluxed and about 100 ml of toluene was removed via the Dean-Stark trap. The toluene in the Dean-Stark trap was clear when water was essentially removed. The suspension was cooled and the product filtered and dried on high vacuum to yield 99.3 g (82.7%) of bis(perfluoro-7-methyloctyl)phosphinic acid, mp 170-172° C.

### Example 9

### Bis(2-tetrafluoroethyl heptafluoroisopropyl ether)phosphinic acid; ((CF₃)₂CFOCF₂CF₂)₂POOH

(CF₃)₂CFOCF₂CF₂I (30.4 g, 0.0717 mol) was dissolved in 350 ml of dry ethyl ether to form a solution. The solution was cooled to −60 to −70° C. in a dry ice/acetone bath. PhMgBr (3M in diethyl ether, 20.8 ml, 0.063 mol) was added so that the temperature remained below −45° C. The mixture was stirred for four hours at −45° C. POCl₃ (2.7 ml, 0.0287 mol) was added so that the temperature remained below −45° C. The mixture was maintained at −40 to −50° C. for 3 hours and then allowed to warm to room temperature overnight. Water (50 ml) was added over 5 to 10 minutes and the solution stirred for one hour. The ether layer was separated and dried with magnesium sulfate. The ether was filtered and concentrated on a rotary evaporator to yield a oily product. The product was triturated three times with hexane, three times with methylene chloride and dried on high vacuum to yield an oily product. The oil was suspended in a flask with 150 ml of toluene and the flask was fitted with a Dean-Stark trap. The toluene was refluxed and about 50 ml of toluene was removed via the Dean-Stark trap. The toluene in the Dean-Stark trap was clear when the water was essentially removed. The suspension was cooled and the product filtered and dried on high vacuum to yield 16.2 g (91.5%) of bis(2-tetrafluoroethyl heptafluoroisopropyl ether)phosphinic acid.

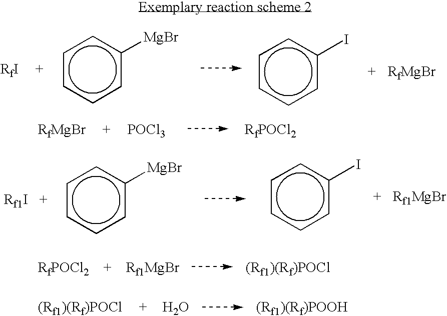

### Example 10

### (N-perfluorooctyl)(n-perfluorohexyl)phosphinic acid; (n-C₈F₁₇)(n-C₆F₁₃)POOH

n-C₈F₁₇I (54.6 g, 0.10 mol) was dissolved in 300 ml of dry ethyl ether to form a solution. The solution was cooled to −60 to −70° C. in a dry ice/acetone bath. PhMgBr (3M in diethyl ether, 33 ml, 0.10 mol) was added so that the temperature remained below −45° C. The mixture was stirred for four hours at −45° C. POCl₃ (9.3 ml, 0.10 mol) was added so that the temperature remained below −45° C. The mixture was maintained at −40 to −50° C. for 3 hours. In a separate flask, n-C₆F₁₃I (44.6 g, 0.10 mol) was dissolved in 300 ml of dry ethyl ether and the solution cooled to −60 to −70° C. in a dry ice/acetone bath. PhMgBr (3M in diethyl ether, 33 ml, 0.10 mol) was added so that the temperature remained below −45° C. The mixture was stirred for four hours at −45° C. This solution was added to the first flask and the reaction allowed to warm to room temperature overnight. Water (100 ml) was added over 5 to 10 minutes and the solution stirred for one hour. The ether layer was separated and dried with magnesium sulfate. The ether was filtered and concentrated on a rotary evaporator to yield a semi solid product. The product was triturated three times with hexane, three times with methylene chloride and dried on high vacuum to yield a solid product. The solid was suspended in a flask with 500 ml of toluene and the flask was fitted with a Dean-Stark trap. The toluene was refluxed and about 100 ml of toluene was removed via the Dean-Stark trap. The toluene in the Dean-Stark trap was clear when the water was essentially removed. The suspension was cooled and the product filtered and dried on high vacuum to yield 43.8 g (54.6%) of (n-perfluorooctyl)(n-perfluorohexyl)phosphinic acid, mp 165-169° C.

### Example 11

### (N-perfluorooctyl)(n-perfluorobutyl)phosphinic acid; (n-C₈F₁₇)(n-C₄F₉)POOH

n-C₈F₁₇I (54.6 g, 0.10 mol) was dissolved in 300 ml of dry ethyl ether to form a solution. The solution was cooled to −60 to −70° C. in a dry ice/acetone bath. PhMgBr (3M in diethyl ether, 33 ml, 0.10 mol) was added so that the temperature remained below −45° C. The mixture was stirred for four hours at −45° C. POCl₃ (9.3 ml, 0.10 mol) was added so that the temperature remained below −45° C. The mixture was maintained at −40 to −50° C. for 3 hours. In a separate flask, n-C₄F₉I (34.6 g, 0.10 mol) was dissolved in 300 ml of dry ethyl ether and the solution cooled to −60 to −70° C. in a dry ice/acetone bath. PhMgBr (3M in diethyl ether, 33 ml, 0.10 mol) was added so that the temperature remained below −45° C. The mixture was stirred for four hours at −45° C. This solution was added to the first flask and the reaction allowed to warm to room temperature overnight. Water (100 ml) was added over 5 to 10 minutes and the solution stirred for one hour. The ether layer was separated and dried with magnesium sulfate. The ether was filtered and concentrated on a rotary evaporator to yield a semi solid product. The product was triturated three times with hexane, three times with methylene chloride and dried on high vacuum to yield a solid product. The solid was suspended in a flask with 500 ml of toluene and the flask was fitted with a Dean-Stark trap. The toluene was refluxed and about 100 ml of toluene was removed via the Dean-Stark trap. The toluene in the Dean-Stark trap was clear when the water was essentially removed. The suspension was cooled and the product filtered and dried on high vacuum to yield 20.7 g (29.5%) of (n-perfluorooctyl)(n-perfluorobutyl)phosphinic acid, mp 165-177° C.

### Example 12

### (N-perfluorooctyl)(n-perfluorodecyl)phosphinic acid; (n-C₈F₁₇)(n-C₁₀F₂₁)POOH

n-C₈F₁₇I (10.9 g, 0.02 mol) was dissolved in 250 ml of dry ethyl ether to form a solution. The solution was cooled to −60 to −70° C. in a dry ice/acetone bath. PhMgBr (3M in diethyl ether, 6.7 ml, 0.02 mol) was added so that the temperature remained below −45° C. The mixture was stirred for four hours at −45° C. POCl₃ (1.85 ml, 0.02 mol) was added so that the temperature remained below −45° C. The mixture was maintained at −40 to −50° C. for 3 hours. In a separate flask, n-C₁₀F₂₁I (12.9 g, 0.02 mol) was dissolved in 300 ml of dry ethyl ether and the solution cooled to −60 to −70° C. in a dry ice/acetone bath. PhMgBr (3M in diethyl ether, 6.7 ml, 0.02 mol) was added so that the temperature remained below −45° C. The mixture was stirred for four hours at −45° C. This solution was added to the first flask and the reaction allowed to warm to room temperature overnight. Water (100 ml) was added over 5 to 10 minutes and the solution stirred for one hour. The ether layer was separated and dried with magnesium sulfate. The ether was filtered and concentrated on a rotary evaporator to yield a semi solid product. The product was triturated three times with hexane, three times with methylene chloride and dried on high vacuum to yield a solid product. The solid was suspended in a flask with 500 ml of toluene and the flask was fitted with a Dean-Stark trap. The toluene was refluxed and about 100 ml of toluene was removed via the Dean-Stark trap. The toluene in the Dean-Stark trap was clear when the water was essentially removed. The suspension was cooled and the product filtered and dried on high vacuum to yield 14.7 g (73.5%) of (n-perfluorooctyl)(n-perfluorodecyl)phosphinic acid, mp 194-199° C.

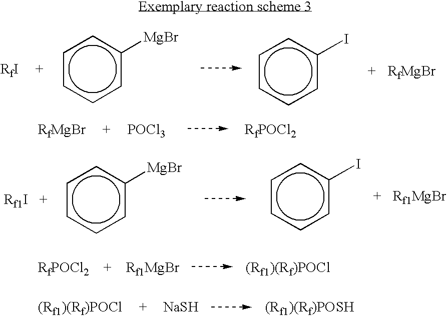

### Example 13

### Bis(n-perfluorooctyl)thiophosphinic acid; (n-C₈F₁₇)₂POSH

n-C₈F₁₇I (27.3 g, 0.05 mol) was dissolved in 1000 ml of dry ethyl ether to form a solution. The solution was cooled to −60 to −70° C. in a dry ice/acetone bath. PhMgBr (3M in diethyl ether, 14.5 ml, 0.05 mol) was added so that the temperature remained below −45° C. The mixture was stirred for four hours at −45° C. POCl₃ (2.33 ml, 0.025 mol) was added so that the temperature remained below −45° C. The mixture was maintained at −40 to −50° C. for 3 hours and then allowed to warm to room temperature overnight. Sodium hydrosulfide (68%, 4.2 g , 0.05 mol) was added in one portion and the reaction refluxed for 4 hours. Water (150 ml) was added over 5 to 10 minutes and the solution stirred for one hour. The ether layer was separated and dried with magnesium sulfate. The ether was filtered and concentrated on a rotary evaporator to yield a pink solid product. The product was triturated three times with hexane, three times with methylene chloride and dried on high vacuum to yield a solid product. The solid was suspended in a flask with 200 ml of toluene and the flask was fitted with a Dean-Stark trap. The toluene was refluxed and about 50 ml of toluene was removed via the Dean-Stark trap. The toluene in the Dean-Stark trap was clear when the water was essentially removed. The suspension was cooled and the product filtered and dried on high vacuum to yield 11.5 g (50.2%) of bis(n-perfluorooctyl)thiophosphinic acid, mp 255-260° C.

### Example 14

### Bis(perfluoro-7-methyloctyl)thiophosphinic acid; ((CF₃)₂CF(CF₂)₆)₂POSH

(CF₃)₂CF(CF)₆I (89.4 g, 0.15 mol) was dissolved in 1000 ml of dry ethyl ether to form a solution. The solution was cooled to −60 to −70° C. in a dry ice/acetone bath. PhMgBr (3M in diethyl ether, 48 ml, 0.16 mol) was added so that the temperature remained below −45° C. The mixture was stirred for four hours at −45° C. POCl₃ (5.6 ml, 0.06 mol) was added so that the temperature remained below −45° C. The mixture was maintained at −40 to −50° C. for 3 hours and then allowed to warm to room temperature overnight. Sodium hydrosulfide (68%, 15 g ) was added in one portion and the reaction refluxed for 4 hours. Water (200 ml) was added over 5 to 10 minutes and the solution stirred for one hour. The ether layer was separated and dried with magnesium sulfate. The ether was filtered and concentrated on a rotary evaporator to yield a pink solid product. The product was triturated three times with hexane, three times with methylene chloride and dried on high vacuum to yield a solid product. The solid was suspended in a flask with 500 ml of toluene and the flask was fitted with a Dean-Stark trap. The toluene was refluxed and about 100 ml of toluene was removed via the Dean-Stark trap. The toluene in the Dean-Stark trap was clear when the water was essentially removed. The suspension was cooled and the product filtered and dried on high vacuum to yield 49.2 g of bis(perfluoro-7-methyloctyl)thiophosphinic acid, mp>300° C.

### Example 15

### Bis(n-perfluorooctyl)phosphinic acid methyl ester; (n-C₈F₁₇)₂POOCH₃

n-C₈F₁₇I (54.6 g, 0.10 mol) was dissolved in 300 ml of dry ethyl ether to form a solution. The solution was cooled to −60° C. to −70° C. in a dry ice/acetone bath. PhMgBr (3M in diethyl ether, 34 ml, 0.10 mol) was added so that the temperature remained below −45° C. The mixture was stirred for four hours at −45° C. POCl₃ (5.1 ml, 0.055 mol) was added so that the temperature remained below −45° C. The mixture was maintained at −40° C. to −5° C. for 3 hours and then allowed to warm to room temperature overnight. Absolute methanol (25 ml) was added in one portion and the reaction refluxed for 1 hour. The reaction was cooled to room temperature. Water (50 ml) was added over 5 to 10 minutes and the solution stirred for one hour. The ether layer was separated and dried with magnesium sulfate. The ether was filtered and concentrated on a rotary evaporator to yield a yellow oil. The product was triturated three times with hexane, three times with methylene chloride and dried on high vacuum to yield a solid product. The solid was suspended in a flask with 500 ml of toluene and the flask was fitted with a Dean-Stark trap. The toluene was refluxed and about 100 ml of toluene was removed via the Dean-Stark trap. The toluene in the Dean-Stark trap was clear when the water was essentially removed. The suspension was cooled and the product filtered and dried on high vacuum to yield 38.0 g (75.4%) of bis(n-perfluorooctyl)phosphinic acid methyl ester, mp 199-202° C.

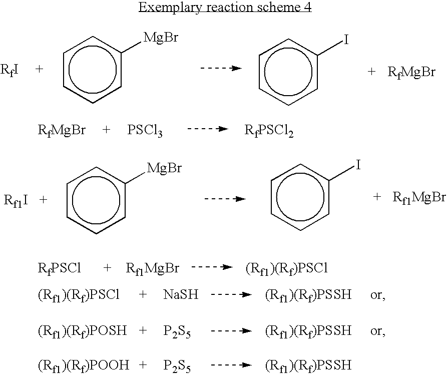

The dithioperfluoroalkylphosphinic acids can be synthesized as outlined in Scheme 4. The experimental procedures are similar to those outlined in the examples.

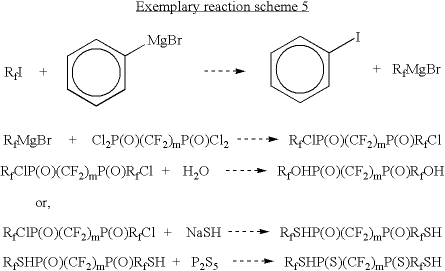

Bisphosphinic acids can be synthesized as outlined in Scheme 5. The experimental procedures are similar to the other examples.

TABLE 1
³¹P NMR of some Exemplary Examples

| | | | | Relative Intensity | |
|---|---|---|---|---|---|
| | | Siganl 1^{a} | Signal 2^{a} | Signal 1/Signal 2 | Other Signals |
| Example | Compound | (ppm) | (ppm) | (Molar %) | ppm (Molar %) |
| 1 | (n-C₈F₁₇)₂POOH | 2.4 p | −1.2 | 98.9% / 0.7% | 6.9 (0.4%) |
| 2 | (n-C₆F₁₃)₂POOH | 2.4 p | −1.2 | 97.2% / 0.7% | 6.9 (2.1%) |
| 3 | (n-C₄F₉)₂POOH | 2.3 p | −1.2 t | 84.4% / trace^{c} | 6.0, 18.8, 27.2 (trace)^{c} |
| 4 | (n-C₂F₅)₂POOH | 4.9 p | 2.0 t | 85.0% / 7.4% | 0.7, 21.2, 29.5 (7.6%) |
| 5 | ((CF₃)₂CF(CF₂)₄)₂P00H | 2.7 p | none | 100% | none |
| 6 | (n-C₁₀F₂₁)₂POOH | 2.6 p | −1.2 t | 96.6% / 3.4% | none |
| 7 | (n-C₁₂F₂₅)₂POOH | b | b | b | b |
| 8 | ((CF₃)₂CF(CF₂)6)₂POOH | 2.5 p | −1.2 t | 97.1% / 0.7% | 18.9, 27.3, 33.8 (2.2%) |
| 9 | ((CF₃)₂CFO(CF₂)₂)₂POOH | 1.1 p | −1.3 t | 94.0% / 3.9% | none |
| 10 | (n-C₈F₁₇)(n-C₆F₁₃)POOH | 2.4 p | −1.3 t | 89.9% / 0% | 6 others (trace^{c}) |
| 11 | (n-C₈F₁₇)(n-C₄F₉)POOH | 4.5 p | 0.7 t | 95.2% / 3.1% | 21.6 (1.7%) |
| 12 | (n-C₈F₁₇(n-C₁₀F₂₁)POOH | 2.7 p | −1.3 t | 73.4% / 26.6% | 1.1 (trace^{c}) |
| 13 | (n-C₈F₁₇)₂POSH | 2.2 p | none | 69.7% / 0% | −3.0 (26.3%), 12.2 (4.0%) |
| 15 | (n-C₈F₁₇)₂POOCH₃ | 2.5 p | −1.2 t | 94.5% / 5.2% | 18.9 (0.3%) |

^{a}p indicates a pentet and t indicates a triplet. These are centered around the indicated chemical shift.
^{b}Since this sample was only partially soluble (in D-acetone), elucidation of these signals was not achieved.
^{c}Not quantifiable since either too many signals or integration was not accurate.

### Example 16

### Fluorescence Lifetime Measurements

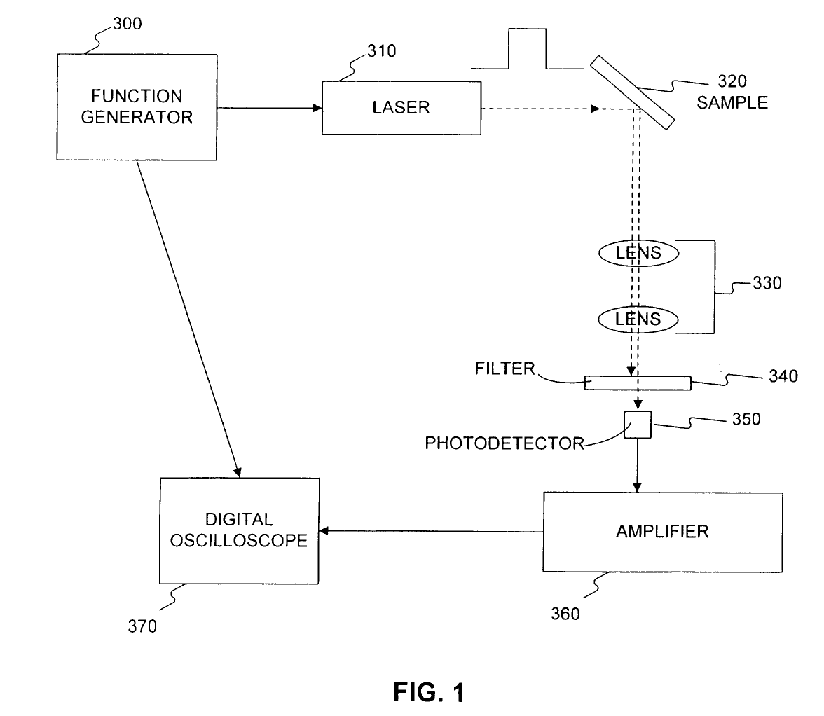

The fluorescence lifetime measurements can be performed using any suitable fluorescence spectrometer using any suitable technique. The measurements reported here were performed using the experimental set-up shown in FIG. 1. The 980 nm diode laser (310) was modulated by function generator WaveTek Model 275 (300) to give a square wave pulse of amplitude 0.5 V and frequency of 10 Hz. The pump beam was expanded before the sample (320), and the fluorescence signal generated was first expanded and then collimated using lenses (320) onto the semiconductor photo-detector (350). A 1550 nm narrow band filter (340) was used in front of the photo-detector to block the pump light. The signal from the photo-detector was amplified with a Model 101C Transimpedance amplifier (360), and the amplified signal was collected by a Tektronix TDS 3032 digital oscilliscope (370) upon being triggered by the trigger signal from the function generator. The metastable state lifetime (τ) was determined by fitting the averaged fluorescence signal (I(t)) to a single exponential decay, I(t)=α+β*exp(−t/τ), where α and β are constant.

A comparison of lifetimes of various Er/Yb complexes is shown in Table 2.

### Example 17

### ³¹P NMR Experiments

The NMR experiments can be performed using any suitable probe, magnetic field and NMR instrument. NMR experiments were recorded at 30° C. on a Bruker DRX 500-MHz spectrometer equipped with a Broadband Observe (BBO), z-axis gradient probe. One dimension ¹H NMR experiments were collected with a 7.5 kHz spectral width and 32 k complex data points. One dimension ³¹P NMR experiments were collected with a 40 kHz spectral width and 32 k complex data points. One dimension ¹⁹F NMR experiments were collected with a 100 kHz spectral width and 128 k complex data points. All NMR data were processed using XWIN NMR program (Bruker).

³¹P NMR data for some of the examples are reported in Table 1.

TABLE 2
Comparison of Lifetimes For Complexes Formed From
This Invention Vs Those Formed From Phosphinic
Acid Via Phosphorous Route

| Er | Yb | |
|---|---|---|
| Stoichiometry | Stoichiometry | Lifetime (ms) |
| 1^{a} | 10^{a} | 4.55^{a} |
| 1 | 10 | 6.3 |
| 1 | 10 | 4.9 |
| 1 | 2.7 | 4.9 |
| 1 | 11 | 7.1 |

The phosphinic acid used in this table is (n-C₈F₁₇)₂POOH. Data in the second through fifth rows are from the present invention.
a Data from phosphorus route (Singh and Shreeve, Inorg. Chem. (2000) vol. 39, pages 1787-1789).

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A compound of formula (I) 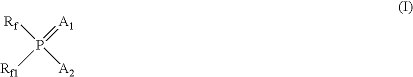
where
A₁ is selected from O and S;
A₂ is selected from —OH, —SH and —OR₃;
R_{f} and R_{f1} can be the same or different, can be branched or unbranched, can be linked to form cyclic or extended structures, and are selected from halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes, halogenated silazanes, halogenated olefins, perfluorinated C₁₋₂₀ alkyl, perfuorinated C₁₋₆ alkyl C₁₋₁₀ alkyl ethers, n-C₈F₁₇, n-C₆F₁₃, n-C₄F₉, n-C₂F₅, (CF₃)₂CF(CF₂)₄, n-C₁₀F₂₁, n-C₁₂F₂₅, (CF₃)₂CF(CF₂)₆, and (CF₃)₂CFO(CF₂)₂; and
R₃ can be branched or unbranched and is selected from C₁₋₁₅ alkyl, C₃₋₁₅ aryl, C₄₋₁₅ alkylaryl and C₄₋₁₅ arylalkyl;
wherein,
(i) if R_{f} and R_{f1} are the same and selected from n-C₂F₅, n-C₄F₉, n-C₆F₁₃, n-C₇F₁₅ and n-C₈F₁₇, then A₁ is not O;
(ii) if R_{f} and R_{f1} are the same and selected from n-C₂F₅, n-C₄F₉, n-C₆F₁₃, n-C₇F₁₅ and n-C₈F₁₇, then A₂ is not —OH; and
(iii) if A₁ is O, and if R_{f} and R_{f1} are the same and selected from n-C₆F₁₃, n-C₇F₁₅ and n-C₈F₁₇, then A₂ is not —OCH₃.

2. The compound of claim 1 wherein R_{f} and R_{f1} can be the same or different, can be branched or unbranched, can be linked to form cyclic or extended structures, and are selected from fluorinated alkyl, fluorinated aryl, fluorinated cyclic alkyl, fluorinated arylalkyl, fluorinated alkylaryl, fluorinated polyether, fluorinated thioether, fluorinated ether thioether, fluorinated aklyl amino groups, fluorinated alkylene, fluorinated silylene, fluorinated siloxanes, fluorinated silazanes, fluorinated olefins, perfluorinated C₁₋₂₀ alkyl, perfuorinated C₁₋₆ alkyl C₁₋₁₀ alkyl ethers, n-C₈F₁₇, n-C₆F₁₃, n-C₄F₉, n-C₂F₅, (CF₃)₂CF(CF₂)₄, n-C₁₀F₂₁, n-C₁₂F₂₅, (CF₃)₂CF(CF₂)₆, and (CF₃)₂CFO(CF₂)₂.

3. The compound of claim 1 wherein R_{f} and R_{f1} can be the same or different, can be branched or unbranched and are selected from fluorinated alkyl, fluorinated polyether, perfluorinated C₁₋₂₀ alkyl, perfuorinated C₁₋₆ alkyl C₁₋₁₀ alkyl ethers, n-C₈F₁₇, n-C₆F₁₃, n-C₄F₉, n-C₂F₅, (CF₃)₂CF(CF₂)₄, n-C₁₀F₂₁, n-C₁₂F₂₅, (CF₃)₂CF(CF₂)₆, and (CF₃)₂CFO(CF₂)₂.

4. The compound of claim 1 wherein R₃ can be branched or unbranched and is selected from a C₁₋₆ alkyl.

5. The compound of claim 1 wherein formula (I) is a compound selected from (n-C₈F₁₇)₂POOH, (n-C₆F₁₃)₂POOH, (n-C₄F₉ )₂POOH, (n-C₂F₅)₂POOH, ((CF₃)₂CF(CF₂)₄)₂POOH, (n-C₁₀F₂₁)₂POOH, (n-C₁₂F₂₅)₂POOH, ((CF₃)₂CF(CF₂)₆)₂POOH, ((CF₃)₂CFO(CF₂)₂)₂POOH, (n-C₈F₁₇)(n-C₆F₁₃)POOH, (n-C₈F₁₇)(n-C₄F₉)POOH, (n-C₈F₁₇)(n-C₁₀F₂₁)POOH, (n-C₈F₁₇)₂POSH, ((CF₃)₂CF(CF₂)₆)₂POSH, and (n-C₈F₁₇)₂POOCH₃.

6. A composition comprising at least one compound of claim 1.

7. An optical composition comprising at least one compound of claim 1.

8. A method of making (R_{f})₂PA₁A₂ comprising:
(a) admixing R_{f}I with RMgBr or RLi at a temperature below about −40° C. to produce a first mixture;
(b) stirring the first mixture for between about 2 to about 6 hours at temperature below about −40° C.;
(c) admixing POCl₃ or PSCl₃ to the first mixture at a temperature below about −40° C. to produce a second mixture;
(d) maintaining the second mixture for about 2 to about 4 hours at a temperature between about −40° C. and about −50° C.;
(e) warming the second mixture to between about 15° C. to about 30° C.;
(f) optionally, admixing NaSH to the second mixture and refluxing for about 2 hours to about 6 hours to produce a third mixture;
(g) admixing water or R₃OH to the second mixture or the third mixture; and
(h) recovering (R_{f})₂PA₁A₂;
wherein,
A₁ is selected from O and S;
A₂ is selected from —OH, —SH and —OR₃;
R_{f} can be branched or unbranched, can be linked to form cyclic or extended structures, and is selected from halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes, halogenated silazanes, halogenated olefins, perfluorinated C₁₋₂₀ alkyl, perfuorinated C₁₋₆ alkyl C₁₋₁₀ alkyl ethers, n-C₈F₁₇, n-C₆F₁₃, n-C₄F₉, n-C₂F₅, (CF₃)₂CF(CF₂)₄, n-C₁₀F₂₁, n-C₁₂F₂₅, (CF₃)₂CF(CF₂)₆, and (CF₃)₂CFO(CF₂)₂;
R₃ can be branched or unbranched and is selected from C₁₋₁₅ alkyl, C₃₋₁₅ aryl, C₄₋₁₅ alkylaryl and C₄₋₁₅ arylalkyl; and
R can be branched or unbranched, and is selected from an alkyl, aryl, alkylaryl, arylalkyl, methyl, ethyl, benzyl and phenyl.

9. The method of claim 8 wherein R_{f} can be branched or unbranched, can be linked to form cyclic or extended structures, and is selected from fluorinated alkyl, fluorinated aryl, fluorinated cyclic alkyl, fluorinated arylalkyl, fluorinated alkylaryl, fluorinated polyether, fluorinated thioether, fluorinated ether thioether, fluorinated aklyl amino groups, fluorinated alkylene, fluorinated silylene, fluorinated siloxanes, fluorinated silazanes, fluorinated olefins, perfluorinated C₁₋₂₀ alkyl, perfuorinated C₁₋₆ alkyl C₁₋₁₀ alkyl ethers, n-C₈F₁₇, n-C₆F₁₃, n-C₄F₉, n-C₂F₅, (CF₃)₂CF(CF₂)₄, n-C₁₀F₂₁, n-C₁₂F₂₅, (CF₃)₂CF(CF₂)₆, and (CF₃)₂CFO(CF₂)₂.

10. The method of claim 8 wherein R_{f} can be branched or unbranched and is selected from fluorinated alkyl, fluorinated polyether, perfluorinated C₁₋₂₀ alkyl, perfuorinated C₁₋₆ alkyl C₁₋₁₀ alkyl ethers, n-C₈F₁₇, n-C₆F₁₃, n-C₄F₉, n-C₂F₅, (CF₃)₂CF(CF₂)₄, n-C₁₀F₂₁, n-C₁₂F₂₅, (CF₃)₂CF(CF₂)₆, and (CF₃)₂CFO(CF₂)₂.

11. The method of claim 8 wherein R₃ can be branched or unbranched and is C₁₋₆ alkyl.

12. The method of claim 8 wherein the compound made is selected from (n-C₈F₁₇)₂POOH, (n-C₆F₁₃)₂POOH, (n-C₄F₉ )₂POOH, (n-C₂F₅)₂POOH, ((CF₃)₂CF(CF₂)₄)₂POOH, (n-C₁₀F₂₁)₂POOH, (n-C₁₂F₂₅)₂POOH, ((CF₃)₂CF(CF₂)₆)₂POOH, ((CF₃)₂CFO(CF₂)₂)₂POOH, (n-C₈F₁₇)₂POSH, ((CF₃)₂CF(CF₂)₆)₂POSH, and (n-C₈F₁₇)₂POOCH₃.

13. The method of claim 8 whereby in step (b) said stirring is for about 4 hours.

14. The method of claim 8 whereby in step (b) said stirring is at a temperature between about −40° C. and about −50° C.

15. The method of claim 8 whereby in step (b) said stirring is at a temperature of about −45° C.

16. The method of claim 8 whereby in step (c) POCl₃ is admixed to the first mixture.

17. The method of claim 8 whereby in step (c) said admixing is at a temperature below about −45° C.

18. The method of claim 8 whereby in step (d) said maintaining is for about 3 hours.

19. The method of claim 8 whereby in step (e) said warming is to between about 20° C. to about 25° C.

20. The method of claim 8 whereby in step (e) said warming is to about room temperature.

21. The method of claim 8 whereby step (f) is not optional.

22. The method of claim 21 whereby said refluxing is for about 4 hours.

23. The method of claim 8 whereby in step (g), water is admixed to the second or third mixture.

24. The method of claim 8 whereby in step (g), R₃OH is admixed to the second or third mixture.

25. The method of claim 8 whereby in step (g), R₃ is selected from a C₁₋₆ alkyl.

26. The method of claim 8 whereby said admixing in step (a) is at a temperature below about −45° C.

27. The method of claim 8 whereby said admixing in step (a) is at a temperature between about −45° C. and about −116° C.

28. A method of making (R_{f})(R_{f1})PA₁A₂ comprising:
(a) admixing R_{f}I with RMgBr or RLi at a temperature below about −40° C. to make a first mixture;
(b) stirring the first mixture for between about 2 to about 6 hours at temperature below about −40° C.;
(c) admixing POCl₃ or PSCl₃ to the first mixture at a temperature below about −40° C. to produce a second mixture;
(d) maintaining said second mixture for about 2 to about 4 hours at a temperature between about −40° C. and about −50° C.;
(e) admixing R_{f1}I with R₁MgBr or R₁Li in a second container at a temperature below about −40° C. to make a third mixture;
(f) stirring said third mixture for between about 2 hours and about 6 hours at temperature below about −40° C.;
(g) admixing the contents of said second container and said first container to make a fourth mixture;
(h) warming said fourth mixture to between about 15° C. to about 30° C.;
(i) optionally, admixing NaSH to said fourth mixture and refluxing for about 2 hours to about 6 hours to produce a fifth mixture;
(j) admixing water or R₃OH to said fourth mixture or said fifth mixture; and
(k) recovering (R_{f})(R_{f1})PA₁A₂;
wherein,
A₁ is selected from O and S;
A₂ is selected from —OH, —SH and —OR₃;
R_{f} and R_{f1} can be the same or different, can be branched or unbranched, can be linked to form cyclic or extended structures, and are selected from halogenated alkyl, halogenated aryl, halogenated cyclic alkyl, halogenated arylalkyl, halogenated alkylaryl, halogenated polyether, halogenated thioether, halogenated ether thioether, halogenated aklyl amino groups, halogenated alkylene, halogenated silylene, halogenated siloxanes, halogenated silazanes, halogenated olefins, perfluorinated C₁₋₂₀ alkyl, perfuorinated C₁₋₆ alkyl C₁₋₁₀ alkyl ethers, n-C₈F₁₇, n-C₆F₁₃, n-C₄F₉, n-C₂F₅, (CF₃)₂CF(CF₂)₄, n-C₁₀F₂₁, n-C₁₂F₂₅, (CF₃)₂CF(CF₂)₆, and (CF₃)₂CFO(CF₂)₂;
R₃ can be branched or unbranched and is selected from C₁₋₁₅ alkyl, C₃₋₁₅ aryl, C₄₋₁₅ alkylaryl and C₄₋₁₅ arylalkyl; and
R and R₁ can be the same or different, can be branched or unbranched, and are selected from an alkyl, aryl, alkylaryl, arylalkyl, methyl, ethyl, benzyl and phenyl.

29. The method of claim 28 wherein R_{f} and R_{f1} can be the same or different, can be branched or unbranched, can be linked to form cyclic or extended structures, and are selected from fluorinated alkyl, fluorinated aryl, fluorinated cyclic alkyl, fluorinated arylalkyl, fluorinated alkylaryl, fluorinated polyether, fluorinated thioether, fluorinated ether thioether, fluorinated aklyl amino groups, fluorinated alkylene, fluorinated silylene, fluorinated siloxanes, fluorinated silazanes, fluorinated olefins, perfluorinated C₁₋₂₀ alkyl, perfuorinated C₁₋₆ alkyl C₁₋₁₀ alkyl ethers, n-C₈F₁₇, n-C₆F₁₃, n-C₄F₉, n-C₂F₅, (CF₃)₂CF(CF₂)₄, n-C₁₀F₂₁, n-C₁₂F₂₅, (CF₃)₂CF(CF₂)₆, and (CF₃)₂CFO(CF₂)₂.

30. The method of claim 28 wherein R_{f} and R_{f1} can be the same or different, can be branched or unbranched and are selected from fluorinated alkyl, fluorinated polyether, perfluorinated C₁₋₂₀ alkyl, perfuorinated C₁₋₆ alkyl C₁₋₁₀ alkyl ethers, n-C₈F₁₇, n-C₆F₁₃, n-C₄F₉, n-C₂F₅, (CF₃)₂CF(CF₂)₄, n-C₁₀F₂₁, n-C₁₂F₂₅, (CF₃)₂CF(CF₂)₆, and (CF₃)₂CFO(CF₂)₂.

31. The method of claim 28 wherein R₃ can be branched or unbranched and is C₁₋₆ alkyl.

32. The method of claim 28 wherein the compound made is selected from (n-C₈F₁₇)₂POOH, (n-C₆F₁₃)₂POOH , (n-C₄F₉)₂POOH, (n-C₂F₅)₂POOH, ((CF₃)₂CF(CF₂)₄)₂POOH, (n-C₁₀F₂₁)₂POOH, (n-C₁₂F₂₅)₂POOH, ((CF₃)₂CF(CF₂)₆)₂POOH, ((CF₃)₂CFO(CF₂)₂)₂POOH, (n-C₈F₁₇)(n-C₆F₁₃)POOH, (n-C₈F₁₇)(n-C₄F₉)POOH, (n-C₈F₁₇)(n-C₁₀F₂₁)POOH, (n-C₈F₁₇)₂POSH, ((CF₃)₂CF(CF₂)₆)₂POSH, and (n-C₈F₁₇)₂POOCH₃.

33. The method of claim 28 whereby in step (b) said stirring is for about 4 hours.

34. The method of claim 28 whereby in step (b) said stirring is at a temperature between about −40° C. and about −50° C.

35. The method of claim 28 whereby in step (b) said stirring is at a temperature of about −45° C.

36. The method of claim 28 whereby in step (c) POCl₃ is admixed to the first mixture.

37. The method of claim 28 whereby in step (c) said admixing is at a temperature below about −45° C.

38. The method of claim 28 whereby in step (d) said maintaining is for about 3 hours.

39. The method of claim 28 whereby in step (f) said stirring is for about 4 hours.

40. The method of claim 28 whereby in step (f) said stirring is at a temperature between about −40° C. and about −50° C.

41. The method of claim 28 whereby in step (f) said stirring is at a temperature of about −45° C.

42. The method of claim 28 whereby in step (h) said warming is to between about 20° C. to about 25° C.

43. The method of claim 28 whereby in step (h) said warming is to about room temperature.

44. The method of claim 28 whereby step (i) is not optional.

45. The method of claim 44 whereby said refluxing is for about 4 hours.

46. The method of claim 28 whereby in step (j), water is admixed to the fourth mixture or the fifth mixture.

47. The method of claim 28 where by in step (j), R₃OH is admixed to the fourth mixture or the fifth mixture.

48. The method of claim 28 whereby in step (j), R₃ is selected from C₁₋₆ alkyl.

49. The method of claim 28 whereby said admixing in step (a) is at a temperature below about −45° C.

50. The method of claim 28 whereby said admixing in step (a) is at a temperature between about −45° C. and about −116° C.

51. The method of claim 28 whereby said admixing in step (e) is at a temperature below about −45° C.

52. The method of claim 28 whereby said admixing in step (e) is at a temperature between about −45° C. and about −116° C.

53. An optical device comprising a composition of claim 6 or 7.

54. The optical device of claim 53 wherein said optical device is selected from optical fiber, waveguide, film, amplifier, laser, multiplexer, isolator, interleaver, demultiplexer, filter, highly-sensitive photodetector and switch.

55. An optical device comprising the composition made according to the method of claim 8.

56. The optical device of claim 55 wherein said optical device is selected from optical fiber, waveguide, film, amplifier, laser, multiplexer, isolator, interleaver, demultiplexer, filter, highly-sensitive photodetector and switch.

57. An optical device comprising the composition made according to the method of claim 28.

58. The optical device of claim 57 wherein said optical device is selected from optical fiber, waveguide, film, amplifier, laser, multiplexer, isolator, interleaver, demultiplexer, filter, highly-sensitive photodetector and switch.
